(19) United States
(12) Patent Application Publication
(10) Pub. No.: US 2019/0316594 A1
(43) Pub. Date: Oct. 17, 2019

(54) ELECTRIC PUMP

(71) Applicant: AISIN SEIKI KABUSHIKI KAISHA, Kariya-shi (JP)

(72) Inventors: Shuji HATTORI, Nagoya-shi (JP); Taichi YOSHIDA, Nagoya-shi (JP); Yuya IMAI, Okazaki-shi (JP); Shinjiro SUZUKI, Kariya-shi (JP)

(73) Assignee: AISIN SEIKI KABUSHIKI KAISHA, Kariya-shi (JP)

(21) Appl. No.: 16/381,500

(22) Filed: Apr. 11, 2019

(30) Foreign Application Priority Data
Apr. 13, 2018 (JP) 2018-077258

(51) Int. Cl. F04D 29/043; F04D 13/06

(52) U.S. Cl. CPC F04D 29/043; F05B 2240/60; F04D 13/06

(57) ABSTRACT

An electric pump includes a shaft, a rotor provided outward in a radial direction of the shaft, and to be rotated to the shaft, an impeller fixed to the rotor, and a cylindrical cap attached to a tip end portion of the shaft. A pump housing includes a suction port provided in an extending direction of the shaft, and a discharge port provided at one side of the impeller and in a direction crossing an extending direction of the shaft. The shaft includes an exposed portion at a tip end side further than a portion to which the cap is attached in the tip end portion. The cap is held by the shaft, prevents the rotor from moving toward a tip end side of the shaft, and includes, on an outer peripheral portion, a first taper portion being decreased in diameter toward the tip end side of the shaft.

### CROSS REFERENCE TO RELATED APPLICATIONS

This application is based on and claims priority under 35 U.S.C. § 119 to Japanese Patent Application 2018-077258, filed on Apr. 13, 2018, the entire content of which is incorporated herein by reference.

### TECHNICAL FIELD

This disclosure generally relates to an electric pump.

### BACKGROUND DISCUSSION

JP2003-129999A (Reference 1) discloses an electric water pump which includes a shaft pivotally supported on a housing, an impeller supported by the shaft and to be rotated, and a permanent magnet fixed on the impeller. The electric water pump in Reference 1 is protrusively formed with a suction port for fluid in the housing and is provided with a cylindrical supporting portion supported by press-fitting one end of the shaft into the suction port.

JP2012-21464A (Reference 2) discloses an electric pump which includes a shaft pivotally supported on a housing, a rotor supported by the shaft and to be rotated, and an impeller provided integrally with the rotor. In the electric pump in Reference 2, a shaft fixation portion is formed to a pump housing which houses the impeller, and one end of the shaft is supported by the shaft fixation portion.

In the electric water pump in Reference 1, the suction port formed in the housing is provided with the shaft and the supporting portion of the shaft. Therefore, the shaft and the supporting portion prevent a flow of fluid sucked from the suction port. Moreover, in the electric pump in Reference 2, the suction port of the pump housing is provided with the shaft fixation portion provided toward an end portion of the shaft from an inner surface of the housing. Therefore, the shaft fixation portion prevents a flow of fluid sucked from the suction port.

A need thus exists for an electric pump which is not susceptible to the drawback mentioned above.

### SUMMARY

An electric pump according to this disclosure includes a motor housing, a pump housing adjacent to the motor housing, a shaft with a base end portion fixed to the motor housing, a rotor housed in the motor housing, provided outward in a radial direction of the shaft, and to be rotated with respect to the shaft, an impeller housed in the pump housing and fixed to the rotor at a side of a tip end portion of the shat, and a cylindrical cap attached to the tip end portion of the shaft. The pump housing includes a suction port provided in an extending direction of the shaft, and a discharge port provided at one side of the impeller and in a direction crossing an extending direction of the shaft. The shaft includes an exposed portion at a tip end side further than a portion to which the cap is attached, in the tip end portion. The cap is held by the shaft, is configured to prevent the rotor from moving toward a tip end side of the shaft, and includes, on an outer peripheral portion, a first taper portion being decreased in diameter toward the tip end side of the shaft.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a cross sectional view illustrating an entire configuration according to a first embodiment;

FIG. 2 is a cross sectional view of a main portion according to the first embodiment;

FIG. 3 is an exploded perspective view of the main portion according to the first embodiment;

FIG. 4 is a cross sectional view of a main portion illustrating a modification example of the first embodiment; and

FIG. 5 is a cross sectional view of a main portion illustrating another embodiment.

### DETAILED DESCRIPTION

Hereinafter, embodiments of this disclosure will be explained with reference to the drawings.

### First Embodiment

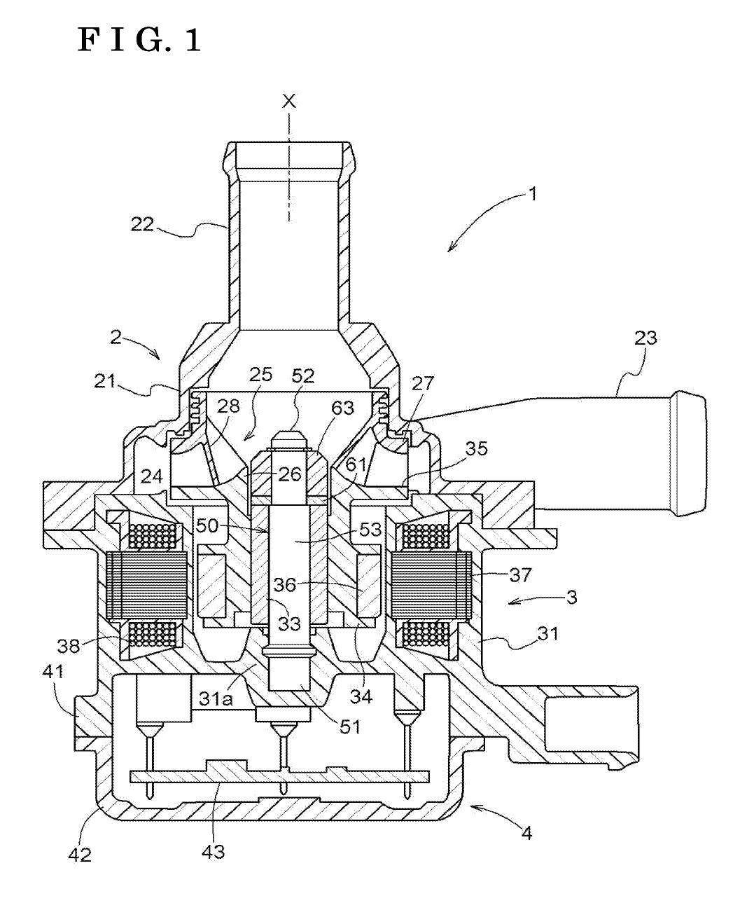

As illustrated in FIG. 1, an electric pump 1 according to this embodiment includes a pump unit 2, a motor unit 3 configured to drive the pump unit 2, and a driver chamber 4 configured to control the motor unit 3. The electric pump 1 includes a resin-made pump housing 21 configured to house the pump unit 2, and a resin-made motor housing 31 which is adjacent to the pump housing 21 and is configured to house the motor unit 3.

The motor unit 3 includes a cylindrical shape shaft 50 (a shaft member) with a circular cross section, a cylindrical bush 33 (a bearing portion), and a rotor 34. A base end portion 51 of the shaft 50 is fixed on a bottom portion 31a of the motor housing 31. The bush 33 is inserted outward in a radial direction of the shaft 50 and is disposed in such a way that the rotor 34 is integrated outward in a radial direction of the bush 33. Thus, the bush 33 and the rotor 34 are rotatably disposed with respect to the shaft 50. In other words, the bush 33 and the rotor 34 integrally rotate with the shaft 50 as a spindle. A magnet 36 is arranged on an outer periphery of the rotor 34, and a stator 37 is arranged at a position opposed to the magnet 36 on an inner surface of the motor housing 31. The stator 37 includes a coil portion 38 wound around with a series of conductive wires via an insulator.

The pump unit 2 is configured by providing an impeller 25 to a flange unit 35 of one end of the rotor 34. The pump housing 21 is formed with a cylindrical suction port 22 and a cylindrical discharge port 23. In the pump housing 21, the suction port 22 is provided in an extending direction of the shaft 50 (a direction of an axis X), and the discharge port 23 is provided at one side of the impeller 25 and in a direction crossing (perpendicularly in the present embodiment) the extending direction of the shaft 50 (the direction of the axis X). Each of the suction port 22 and the discharge port 23 communicates with an impeller chamber 24 formed in the pump housing 21. The impeller chamber 24 houses the impeller 25, and the impeller 25 integrally rotates with the rotor 34, which sucks fluid (for example, cooling water) to the impeller chamber 24 from the suction port 22 and discharges the fluid to the discharge port 23 from the impeller chamber 24.

In the electric pump 1, an engine control unit (ECU) in a vehicle (not illustrated) controls an electric current to a coil of the coil portion 38 wound on the stator 37 via a driver 43, and thus the magnet 36 of the rotor 34 receive an alternating magnetic field, the bush 33 and the rotor 34 integrally rotate, and the impeller 25 rotates with the rotor 34.

The driver chamber 4 is formed by a driver case 41 formed integrally with the motor housing 31 and a cover body 42 fixed by welding to the driver case 41, and thus internally houses the driver 43.

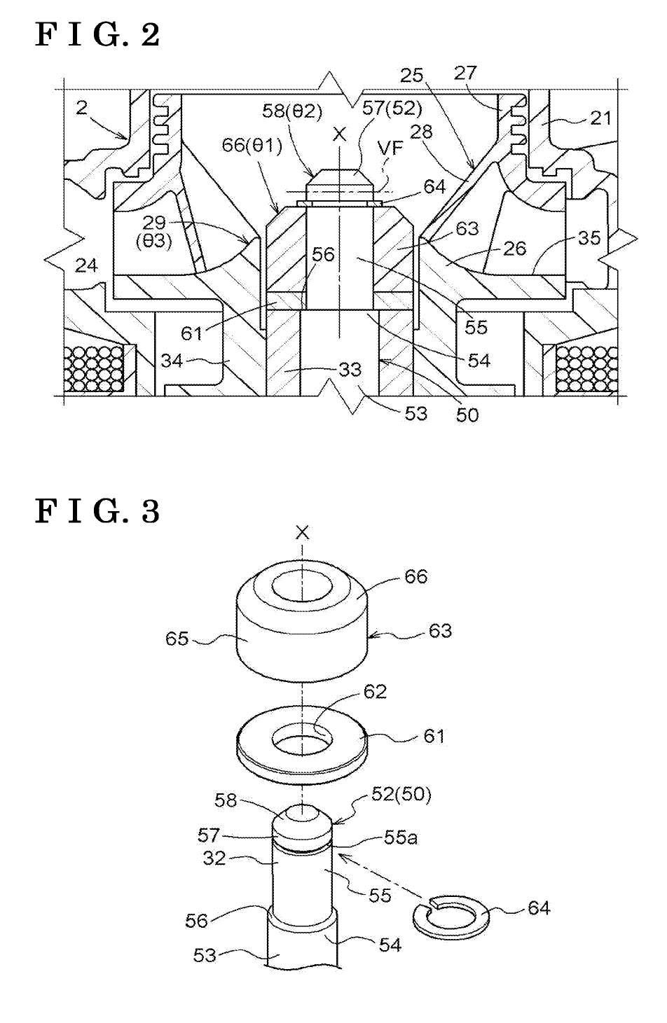

As illustrated in FIGS. 1 and 2, the impeller 25 includes a base unit 26 extended toward a tip end side of the shaft 50 from the flange unit 35, and a shroud 27, and includes a plurality of curved blade members 28 inside the shroud 27. The impeller 25 is covered with the resin-made pump housing 21. These blade members 28 are fixed to the base unit 26 through vibration welding, for example.

As illustrated in FIGS. 2 and 3, a tip end portion 52 located at a side opposite to the base end portion 51 of the shaft 50 is provided with a first shaft portion 55 toward a tip end from an end portion 54 of a main shaft portion 53. The first shaft portion 55 is coaxial with the main shaft portion 53 and is smaller in diameter than the main shaft portion 53 (the end portion 54). A step portion 56 is formed at a boundary between the end portion 54 of the main shaft portion 53 and the first shaft portion 55. The first shaft portion 55 is assembled with a washer 61 which allows movement in the direction of the axis X. The washer 61 has a circular inner hole 62 whose diameter is larger than a diameter of the first shaft portion 55 and is smaller than a diameter of the main shaft portion 53 (the end portion 54). The washer 61 is disposed so as to bring into contact with the step portion 56 and the bush 33. The washer 61 is interposed between the bush 33 and a cap 63 (described later), and thus prevents the bush 33 from bringing into sliding contact with the cap 63 and wearing down the cap 63. Note that the washer 61 may be rotatable or non-rotatable with respect to the shaft 50.

Further, the first shaft portion 55 is attached with the cap 63 formed in a cylindrical shape and a retaining ring 64. The cap 63 is disposed so as to bring into contact with the washer 61. The retaining ring 64 is assembled with a tip end side further than the cap 63 in the first shaft portion 55 so as to prevent the cap 63 from falling out of the first shaft portion 55. The first shaft portion 55 is formed with a groove portion 55a for assembling the retaining ring 64 on an outer peripheral portion. The retaining ring 64 is configured by a C-shaped ring, for example. The retaining ring 64 is formed of a metal material such as stainless and has a biasing force in a diameter-decreasing direction with respect to the first shaft portion 55.

Thus, in the tip end portion 52 of the pump housing side of the shaft 50, the washer 61, the cap 63, and the retaining ring 64 are assembled in this order toward the tip end side. This prevents the rotor 34 from moving toward a tip end side of the tip end portion 52 of the shaft 50. As a result, the rotor 34 can be held at an appropriate position in the direction of the axis X of the shaft 50.

Moreover, the first shaft portion 55 of the shaft 50 includes an exposed portion 57 at a tip end side further than a portion to which the cap 63 is attached. In other words, in the first shaft portion 55, the tip end portion 52 of the shaft 50 is configured by including a portion to which the washer 61 and the cap 63 are attached and the exposed portion 57 of the tip end side. Accordingly, a flow passage leading toward the tip end portion 52 of the shaft 50 from the suction port 22 is not provided with, for example, the shaft fixation portion and the like extended toward the shaft 50 from the pump housing 21. Therefore, it is possible to effectively flow fluid sucked from the suction port 22 toward the impeller 25 without being prevented by the shaft fixation portion and the like.

The cap 63 includes, on an outer peripheral portion 65, a first taper portion 66 being decreased in diameter toward the tip end side of the shaft 50. Since the first taper portion 66 is provided, fluid of the suction port 22 is guided toward the impeller 25 by the first taper portion 66, which makes it possible to generate a smoother flow of fluid from the suction port 22 to the impeller 25. This improves pump efficiency of the electric pump 1.

The exposed portion 57 of the shaft 50 positioned at the suction port 22 side further than the cap 63 includes a second taper portion 58 being decreased in diameter toward the tip end of the tip end portion 52 of the shaft 50. This allows the pump unit 2 to generate a smooth flow of fluid sucked from the suction port 22 further to the impeller 25 also in the exposed portion 57 of the shaft 50 on an upstream side of the cap 63.

As illustrated in FIG. 2, the base unit 26 of the impeller 25 includes a third taper portion 29 being decreased in diameter toward the tip end side of the tip end portion 52 of the shaft 50, at a portion adjacent to the cap 63 in an outer peripheral side of the shaft 50. Since the impeller 25 has the third taper portion 29, fluid sucked from the suction port 22 to the impeller 25 is guided to the third taper portion 29, thereby facilitating flow of fluid toward the discharge port 23. This yields further improvement in pump efficiency of the electric pump 1.

Herein, in this embodiment, all inclinations relative to a virtual plane VF perpendicular to an extending direction of the shaft 50 are the same in the first taper portion 66, the second taper portion 58, and the third taper portion 29. In other words, in a case where inclinations of the first taper portion 66, the second taper portion 58, and the third taper portion 29 relative to the virtual plane VF are set to θ1, θ2, and θ3, respectively, the inclinations are configured to have a relationship of “θ1=θ2=θ3. ” This can facilitate flow of fluid from the tip end side of the shaft 50 toward the cap 63 and the impeller 25.

### Modification Example of First Embodiment

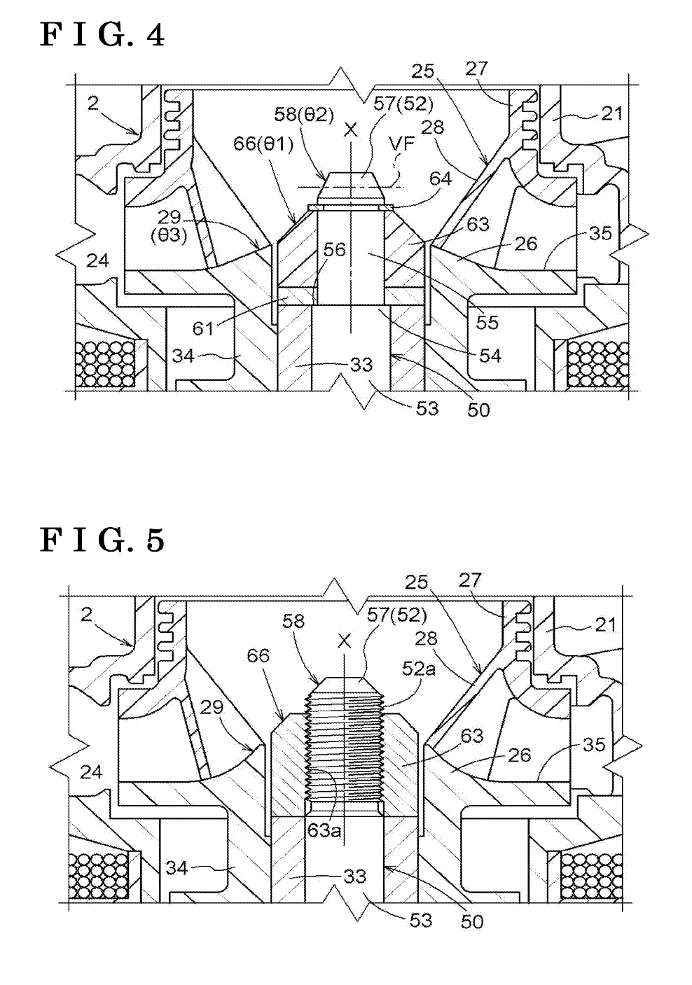

In this modification example illustrated in FIG. 4, the first taper portion 66, the second taper portion 58, and the third taper portion 29 are formed in such a way that inclinations relative to a virtual plane VF perpendicular to an extending direction of the shaft 50 become gentler toward the base unit 26 of the impeller 25 from the tip end side of the tip end portion 52 of the shaft 50. In other words, inclinations θ1 to θ3 of the first taper portion 66, the second taper portion 58, and the third taper portion 29 relative to the virtual plane VF are configured to have a relationship of “θ2>θ1>θ3.” Thus, a taper surface of the second taper portion 58 comes close to a flow direction of fluid flowed from the suction port 22, thereby facilitating flow of fluid from the tip end side of the tip end portion 52 of the shaft 50 toward the discharge port 23 via the cap 63 and the impeller 25.

### Other Embodiments

(1) The above-described embodiment illustrates the configuration example of preventing a fall of the rotor 34 and the bush 33 by the washer 61, the cap 63, and the retaining ring 64. However, as illustrated in FIG. 5, only the cap 63 made of metal may be attached to the tip end portion 52 of the shaft 50 without using the washer 61 and the retaining ring 64. In this case, for example, a male screw portion is provided to an outer peripheral portion 52a of the tip end portion 52 of the shaft 50 and a female screw portion is provided to an inner peripheral portion 63a of the cap 63, which makes it possible to screw the cap 63 to the tip end portion 52 of the shaft 50.

(2) The cap 63 may be press-fitted in the shaft 50. In this case, use of the washer 61 and the retaining ring 64 is optional. For example, the cap 63 and the retaining ring 64 may be configured so as to prevent a fall of the rotor 34 and the bush 33, and the cap 63 and the washer 61 may be configured so as to prevent a fall of the rotor 34 and the bush 33, without using the retaining ring 64. Alternatively, the cap 63 may be adhered and fixed to the tip end portion 52 of the shaft 50.

This disclosure is applicable to an electric pump for circulating various types of fluid.

An electric pump according to this disclosure includes a motor housing, a pump housing adjacent to the motor housing, a shaft with a base end portion fixed to the motor housing, a rotor housed in the motor housing, provided outward in a radial direction of the shaft, and to be rotated with respect to the shaft, an impeller housed in the pump housing and fixed to the rotor at a side of a tip end portion of the shat, and a cylindrical cap attached to the tip end portion of the shaft. The pump housing includes a suction port provided in an extending direction of the shaft, and a discharge port provided at one side of the impeller and in a direction crossing an extending direction of the shaft. The shaft includes an exposed portion at a tip end side further than a portion to which the cap is attached, in the tip end portion. The cap is held by the shaft, is configured to prevent the rotor from moving toward a tip end side of the shaft, and includes, on an outer peripheral portion, a first taper portion being decreased in diameter toward the tip end side of the shaft.

With this configuration, in the electric pump, the shaft which rotatably supports the rotor is formed in such a way that the base end portion is fixed to the motor housing and the cylindrical cap is attached to a tip end portion. The cap is held by the shaft and prevents the rotor from moving toward a tip end side of the shaft, thereby making it possible to position the rotor in the shaft by the cap.

Moreover, the shaft includes the exposed portion at a tip end side further than a portion to which the cap is attached in the tip end portion. In other words, the tip end portion of the shaft is configured by the portion to which the cap is attached and the exposed portion of the tip end side further than the portion to which the cap is attached. Accordingly, a flow passage leading toward the tip end portion of the shaft from the suction port is not provided with, for example, a shaft fixation portion or the like extended toward the shaft from the pump housing. Therefore, it is possible to efficiently flow fluid sucked from the suction port toward the impeller without being prevented by the shaft fixation portion or the like.

Further, the cap includes, on an outer peripheral portion, the first taper portion being decreased in diameter toward the tip end side of the shaft, and thus the fluid of the suction port is guided toward the impeller by the first taper portion, which makes it possible to generate a smooth flow of fluid flowing toward the impeller via the cap. This improves pump efficiency of the electric pump.

In another aspect, the exposed portion of the shaft may have a second taper portion being decreased in diameter toward the tip end of the shaft.

With this configuration, in addition to the first taper portion included in the cap, the exposed portion of the shaft positioned at the suction port side further than the cap includes the second taper portion being decreased in diameter toward the tip end of the shaft. This allows fluid flowing toward the tip end portion of the shaft from the suction port to be guided toward the impeller by the second taper portion of the shaft. This achieves a smoother flow of fluid flowing toward the impeller via the tip end portion of the shaft from the suction port.

In another aspect, the impeller may include a third taper portion being decreased in diameter toward the tip end side of the shaft at a portion adjacent to the cap on an outer peripheral side of the shaft. Moreover, the first taper portion of the cap, the second taper portion of the shaft, and the third taper portion of the impeller may be formed in such a way that all inclinations relative to a virtual plane perpendicular to an extending direction of the shaft are the same, or the inclinations become gentler toward the impeller from a tip end of the tip end portion of the shaft.

With this configuration, in addition to the first taper portion of the cap and the second taper portion of the shaft, the impeller includes the third taper portion being decreased in diameter toward the tip end side of the shaft at a portion adjacent to the cap on an outer peripheral side of the shaft. This allows fluid flowed toward the impeller from the suction port to be guided to a discharge port by the third taper portion. This achieves a smoother flow of fluid flowing toward the discharge port via the impeller from the suction port.

Herein, in a case where the first taper portion, the second taper portion, and the third taper portion are formed in such a way that all inclinations relative to a virtual plane perpendicular to an extending direction of the shaft are the same, fluid flowing toward the cap and the impeller from the tip end side of the shaft is guided by the taper portion having the same inclination, which facilitates flow of the fluid.

Moreover, in a case where the first taper portion, the second taper portion, and the third taper portion are formed in such a way that the inclinations become gentler toward the impeller from the tip end side of the shaft, this facilitates flow of fluid introduced from the tip end side of the shaft readily to the discharge port by the gradually gentler inclination. This achieves a smoother flow of fluid flowing toward the discharge port via the impeller from the suction port.

In another aspect, the tip end portion of the shaft may be attached with a retaining ring which prevents a fall of the cap. Moreover, a male screw may be provided to an outer peripheral portion of the tip end portion of the shaft, a female screw portion may be provided to an inner peripheral portion of the cap, and the cap may be screwed to the tip end portion of the shaft. Furthermore, the cap may be attached to the shaft by press-fitting.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. An electric pump, comprising:
a motor housing, and a pump housing adjacent to the motor housing;
a shaft including a base end portion fixed to the motor housing;
a rotor housed in the motor housing, provided outward in a radial direction of the shaft, and to be rotated with respect to the shaft; and
an impeller housed in the pump housing and fixed to the rotor at a side of a tip end portion of the shat, and a cylindrical cap attached to the tip end portion of the shaft, wherein
the pump housing includes a suction port provided in an extending direction of the shaft, and a discharge port provided at one side of the impeller and in a direction crossing an extending direction of the shaft,
the shaft includes an exposed portion at a tip end side further than a portion to which the cap is attached in the tip end portion, and
the cap is held by the shaft, is configured to prevent the rotor from moving toward a tip end side of the shaft, and includes, on an outer peripheral portion, a first taper portion being decreased in diameter toward a tip end side of the shaft.

2. The electric pump according to claim 1, wherein the exposed portion of the shaft includes a second taper portion being decreased in diameter toward a tip end of the shaft.

3. The electric pump according to claim 2, wherein
the impeller includes a third taper portion being decreased in diameter toward a tip end side of the shaft at a portion adjacent to the cap on an outer peripheral side of the shaft.

4. The electric pump according to claim 3, wherein
the first taper portion of the cap, the second taper portion of the shaft, and the third taper portion of the impeller are formed in such a way that all inclinations relative to a virtual plane perpendicular to an extending direction of the shaft are same.

5. The electric pump according to claim 3, wherein
the first taper portion of the cap, the second taper portion of the shaft, and the third taper portion of the impeller are formed in such a way that inclinations relative to a virtual plane perpendicular to an extending direction of the shaft become gentler toward the impeller from a tip end of the tip end portion of the shaft.

6. The electric pump according to claim 1, wherein the tip end portion of the shaft is attached with a retaining ring which prevents a fall of the cap.

7. The electric pump according to claim 4, wherein the tip end portion of the shaft is attached with a retaining ring which prevents a fall of the cap.

8. The electric pump according to claim 5, wherein the tip end portion of the shaft is attached with a retaining ring which prevents a fall of the cap.

9. The electric pump according to claim 1, wherein a male screw is provided to an outer peripheral portion of the tip end portion of the shaft, a female screw portion is provided to an inner peripheral portion of the cap, and the cap is screwed to the tip end portion of the shaft.

10. The electric pump according to claim 4, wherein a male screw is provided to an outer peripheral portion of the tip end portion of the shaft, a female screw portion is provided to an inner peripheral portion of the cap, and the cap is screwed to the tip end portion of the shaft.

11. The electric pump according to claim 5, wherein a male screw is provided to an outer peripheral portion of the tip end portion of the shaft, a female screw portion is provided to an inner peripheral portion of the cap, and the cap is screwed to the tip end portion of the shaft.

12. The electric pump according to claim 1, wherein the cap is attached to the shaft by press- fitting.

13. The electric pump according to claim 4, wherein the cap is attached to the shaft by press- fitting.

14. The electric pump according to claim 5, wherein the cap is attached to the shaft by press- fitting.
